(19) United States
(12) Patent Application Publication
(10) Pub. No.: US 2020/0184522 A1
(43) Pub. Date: Jun. 11, 2020

(54) METHOD AND SYSTEM FOR CLICK-DRIVEN VALUE IDENTIFICATION

(71) Applicants: Beijing Jingdong Shangke Information Technology Co., Ltd., Beijing (CN); JD.com America Technologies Corporation, Mountain View, CA (US)

(72) Inventors: Rong Yuan, Mountain View, CA (US); Di Wu, Mountain View, CA (US); Juxin Li, Beijing (CN)

(21) Appl. No.: 16/216,867

(22) Filed: Dec. 11, 2018

(51) Int. Cl. G06Q 30/02; G06Q 30/06

(52) U.S. Cl. CPC G06Q 30/0282; G06Q 30/0641; G06Q 30/0201

(57) ABSTRACT

Systems and methods for calculating a product Click-Driven Value (CDV) of a first product. The method includes: receiving, by a computing device, multiple customer clicks on the first product; determining, by the computing device, a click CDV for each of the customer clicks based on profit of multiple second products associated with the customer click; and calculating, by the computing device, the product CDV of the first product by averaging the click CDVs for all of the customer clicks on the first product.

### CROSS-REFERENCES

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD

The present disclosure relates generally to the field of e-commerce, and more particularly to a method and a system for identifying a click-driven value (CDV) for a product based on customer clicks on the product.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A behavior of a customer clicking a product webpage on an e-commerce website is valuable for e-commerce. For example, a click on a webpage of a product may not only leave an impression to the customer, which may directly contribute to gaining customer loyalty, but also may serve as a comparison with other products, which may directly facilitate purchase decisions of the customer. However, it is hard to accurately estimate the value of the customer clicks.

Therefore, an unaddressed need exists in the art to address the aforementioned deficiencies and inadequacies.

### SUMMARY

In certain aspects, the present disclosure relates to a method for calculating a product Click-Driven Value (CDV) of a first product. In certain embodiments, the method includes:

receiving, by a computing device, a plurality of customer clicks on the first product;

determining, by the computing device, a click CDV for each of the customer clicks based on profit of a plurality of second products sold after the customer click and associated with the customer click; and

calculating, by the computing device, the product CDV of the first product by averaging the click CDVs for all of the customer clicks on the first product.

In certain embodiments, the method retrieves the customer clicks on the first product within the first predetermined time prior to the current time, and the step of determining the click CDV includes:

identifying a set O(i) of the second products j association with a customer click i of the customer clicks, wherein each of the second product j in the set O(i) is purchased by the customer performing the customer click i within a second predetermined time after the customer click i;

retrieving a profit wⱼ for selling each of the second products j in the set O(i);

deriving, for each product j in the set O(i), an explanatory power factor aᵢⱼ according to at least one of the click history and sale history of the first product, the second products, and products associated with the first and second products; and

calculating the click CDV vᵢ for the customer click i using the equation:

vᵢ=Σ_{jϵO(i)}aᵢⱼwⱼ,

where i is an index for the customer click i, j is an index for the second products in the set O(i), and i and j are positive integers.

In certain embodiments, for each product j in the set O(i), the explanatory power factor aᵢⱼ is derived using the formula:

aᵢⱼ=sᵢⱼdᵢⱼ,

where sᵢⱼ is a substitutional effect parameter representing a substitutional effect of using the second product j to substitute the first product; and

where dᵢⱼ is a dominance effect parameter representing a dominance effect of the first product to sale of the second product j.

In certain embodiments, the substitutional effect parameter sᵢⱼ is determined using an equation:

$${s}_{ij} = \frac{2 ( \overline{{q}_{ij}} - \overline{{u}_{j}} )}{{\overline{u}}_{i} + {Σ}_{k} \overline{( {q}_{ik}} - \overline{{u}_{k} )}} ,$$

where q̅ᵢ̅ⱼ̅ is an average sale amount of the second product j when the first product i is out of stock in a third predetermined time, u̅ⱼ̅ represents an average sale amount of the second product j in the third predetermined time (or when the first product i is in stock during the third predetermined time), q̅ₜ̅ₖ̅ is an average sale amount of one of k products when the first product i is out of stock in the third predetermined time, u̅ₖ̅ represents an average sale amount of the one of the k products in the third predetermined time (or when the first product i is in stock during the third predetermined time), k is a positive integer, and the k products and the product t i belong to a same product category.

In certain embodiments, the dominance effect parameter dᵢⱼ is determined using an equation:

$${d}_{ij} = \frac{{r}_{i}}{{Σ}_{k ∈ C ( j )} {r}_{k}} ,$$

where rᵢ is a sale price of the first product i, O(j) is a set of products clicked within a fourth predetermined time prior to the sale of the second product j, q is an index for the products in the set O(j) and is a positive integer, and r_{q} is a sale price of the product q.

In certain embodiments, the first predetermined time is half a year or one year, the second predetermined time is two weeks or one week, the third predetermined time is half a year or one year, and the fourth predetermined time is two weeks or one week. In one embodiment, the first predetermined time is half a year, the second predetermined time is two weeks, the third predetermined time is half a year, and the fourth predetermined time is two weeks.

In certain embodiments, the substitutional effect parameter is determined by:

$${s}_{ij} = \frac{{c}_{1} ( \overline{{q}_{ij}} - \overline{{u}_{j}} )}{{c}_{2} + {Σ}_{k} \overline{( {q}_{ik}} - \overline{{u}_{k} )}} ,$$

where c₁ and c₂ are constants, represents an average sale amount of the second product j when the first product i is out of stock in a third predetermined time, u̅ⱼ̅ represents an average sale amount of the second product j in the third predetermined time (or when the first product i is in stock during the third predetermined time), q̅ₜ̅ₖ̅ is an average sale amount of one of k products when the first product i is out of stock in the third predetermined time, u̅ₖ̅ represents an average sale amount of the one of the k products in the third predetermined time, k is a positive integer, and the k products and the product t i belong to a same product category. In certain embodiments, c₁ is in a range of 1-3, c₂ is in a range of 0.5-3, the first predetermined time is half a year, the second predetermined time is two weeks, and the third predetermined time is half a year. In certain embodiments, c₁ is 2 and c₂ is 1.

In certain embodiments, the substitutional effect parameter sᵢⱼ is determined by:

$${s}_{ij} = \frac{c ( \overline{{q}_{ij}} - \overline{{u}_{j}} )}{{\overline{u}}_{i} + {Σ}_{k} \overline{( {q}_{ik}} - \overline{{u}_{k} )}} ,$$

where c is a constant, q̅ᵢ̅ⱼ̅ represents an average sale amount of the second product j when the first product i is out of stock in a third predetermined time, u̅ⱼ̅ represents an average sale amount of the second product j in the third predetermined time, u̅ᵢ̅ represents an average sale amount of the first product i during the third period of time, q̅ₜ̅ₖ̅ is an average sale amount of one of k products when the first product i is out of stock in the third predetermined time, u̅ₖ̅ represents an average sale amount of the one of the k products in the third predetermined time, k is a positive integer, and the k products and the product i belong to a same product category. In certain embodiments, c is in a range of 1-3, the first predetermined time is half a year, the second predetermined time is two weeks, and the third predetermined time is half a year. In certain embodiments, c is 2 or 1.

In certain embodiments, the method further includes deciding whether to carry the first product and an amount of the first product to carry, by an Inventory Planning and Control System (IPCS) in communication with the computing device, based on the calculated product CDV for the first product.

In certain embodiments, the method further includes deciding how much to spend on acquiring a customer, by a Marketing Planning System (MPS) in communication with the computing device, based on the calculated product CDV for the first product.

In certain aspects, the present disclosure relates to a system for calculating a product Click-Driven Value (CDV) of a first product. In certain embodiments, the system includes a computing device. The computing device has a processor and a storage device storing computer executable code. The computer executable code, when executed at the processor, is configured to perform the method described above.

In certain aspects, the present disclosure relates to a non-transitory computer readable medium storing computer executable code. The computer executable code, when executed at a processor of a computing device, is configured to perform the method as described above.

These and other aspects of the present disclosure will become apparent from following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 schematically depicts a click-driven value (CDV) identification system structure according to certain embodiment of the present disclosure.

FIG. 2 schematically depicts a CDV identification system according to certain embodiment of the present disclosure.

FIG. 3 schematically depicts a process of determining a CDV for a single customer click on a product (click CDV) according to certain embodiment of the present disclosure.

FIG. 4 schematically depicts a process of identifying a CDV for a product (product CDV) according to certain embodiment of the present disclosure.

FIG. 5 schematically depicts a method of identifying a CDV of a product according to certain embodiments of the present disclosure.

FIG. 6 schematically depicts a method of determining a substitutional effect parameter according to certain embodiments of the present disclosure.

FIG. 7 schematically depicts a method of determining a dominance effect parameter according to certain embodiments of the present disclosure.

FIGS. 8A-8D schematically depict an example according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Unless otherwise defined, “first”, “second”, “third” and the like used before the same object are intended to distinguish these different objects, but are not to limit any sequence thereof.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

As used herein, “plurality” means two or more.

As used herein, the terms “comprising”, “including”, “carrying”, “having”, “containing”, “involving”, and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure. As used herein, the term “and/or” includes any and all combinations of one or more of the associated listed items.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The present disclosure relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the present disclosure are shown. This disclosure may, however, be embodied in many different forms and should not be construed as limited to the embodiments set forth herein; rather, these embodiments are provided so that this disclosure will be thorough and complete, and will fully convey the scope of the present disclosure to those skilled in the art.

In certain aspects, the present disclosure define a dollar value for customer clicks on a product, which is also referred to as a Click-Driven Value (CDV). In certain embodiments, a value of a customer click is termed click CDV, and a value of a product page based on the click CDVs from different customers is termed product CDV or CDV. Due to uncertainty of the customer's behavior associated with the click and a huge number of customers on an e-commerce platform, it is difficult to accurately evaluate the CDVs. By providing systems and methods to determine the click CDVs and product CDVs, the present disclosure estimates accurately profit that the customer's browsing behavior can bring to the business, identifies which of products may be more important to the customer, helps choosing the right products and the right number of products to stock in warehouses, and helps pricing correctly advertisements associated with the webpage of the products.

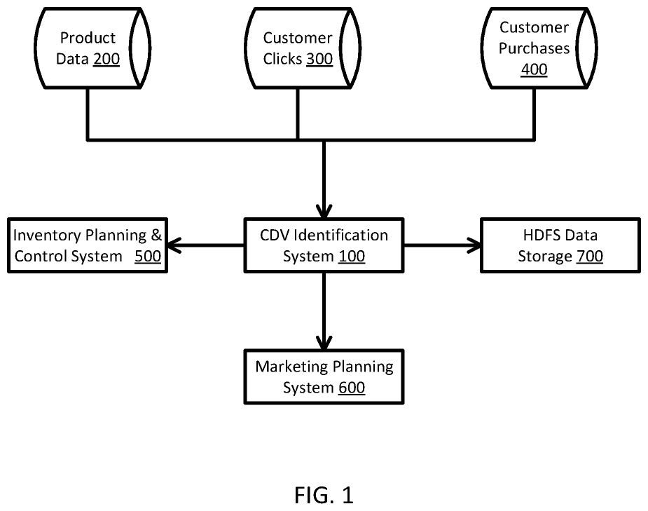

FIG. 1 schematically depicts a click-driven value identification system structure according to certain embodiment of the present disclosure. As shown in FIG. 1, the system structure includes a CDV identification system 100, customer clicks 200, customer purchases 300, product data 400, an inventory planning & controlling system (IPCS) 500, a marketing planning system (MPS) 600, and a Hadoop distributed file system (HDFS) data storage 700.

The CDV identification system 100 is configured to identify CDV for each of the products in an e-commerce platform. The customer clicks 200 records click history of customers on product pages. Each click record of the click history may include, among other things, the identification of the click, the time of the click, the customer performing the click, the product page the click performed on, and the identification of the product. The customer purchases 300 records purchase history of customers (or sale history of the e-commerce platform) on products. Each purchase record of the purchase history may include, among other things, the time of the purchase, the customer making the purchase, the product page corresponding to the purchased product, the purchase price, the profit earned by the e-commerce platform on the purchase, and the identification of the product. The product data 400 includes record of the products provided by the e-commerce platform. Each product record may include, among other things, the identification of the product, the category of the products, the features of the products such as weight, size and materials, the cost of the product, and the sale price of the product. In certain embodiments, there are hierarchical categories for the product. For example, the categories may include a first category of “food & beverage,” which includes a second category of “drinks,” which includes a third category of “soft drinks.” In certain embodiments, the sale prices and profits for the products may also be stored to the product data 400 instead of the customer purchases 300. The IPCS 500 is configured to monitor the inventory of the products and provide strategies of controlling the inventory, etc. The MPS 600 is configured to provide strategies of planning marketing activities based. In certain embodiments, the CDV identification system 100 is installed and operated on a Hadoop cloud computing platform, and the HDFS data storage 700 provides support for the CDV identification system 100.

The systems and data bases 100-700 may be in communication with each other through wired or wireless network, and each of them may be operated on a cloud computing system. As shown in FIG. 1, the CDV value identification system 100 is configured to retrieve data from the customer clicks 100, the customer purchases 200 and the product data 300, identify CDV for the products, send the CDV to the IPCS 500 for its inventory planning, send the CDV to the MPS 600 for its marketing planning, and store the CDV of the product regularly to the HDFS data storage 700. Kindly note the arrow direction between the systems 100-700 indicates the data flow described above as an example, but the systems 100-700 in practice may communicate with each other bi-directionally.

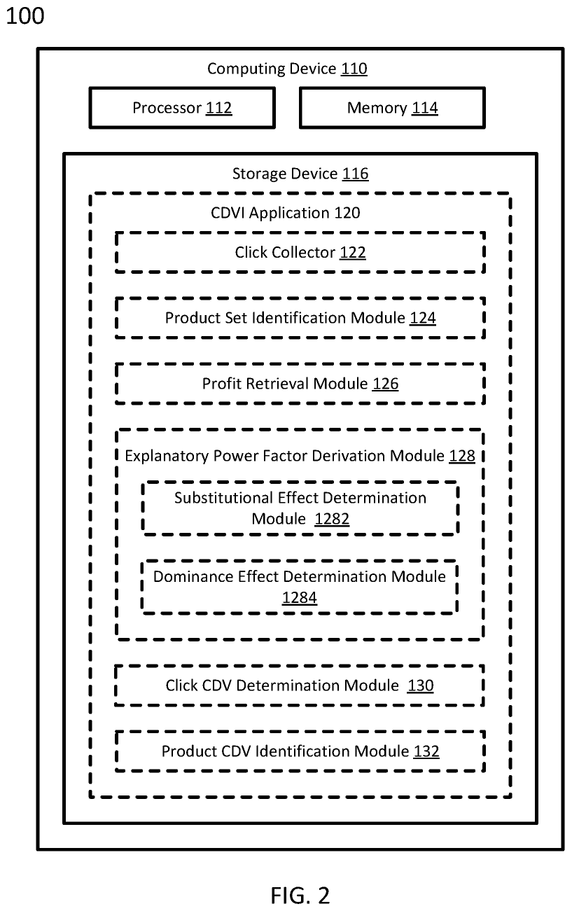

FIG. 2 schematically depicts a CDV identification system according to certain embodiments of the present disclosure. In certain embodiments, the CDV identification system 100 includes a computing device 110. The computing device 110 may be used for implementing the system for identifying a CDV for a product (or product CDV) based on customer clicks on the product. In certain embodiments, the computing device 110 may be a server computer, a cluster, a cloud computer, a general-purpose computer, or a specialized computer, which can identify a CDV for a product based on customer clicks on the product. The CDV for the product is a measure of benefit gained from the customer clicks on the product.

As shown in FIG. 2, the computing device 110 may include, without being limited to, a processor 112, a memory 114, and a storage device 116. In certain embodiments, the computing device 110 may include other hardware components and software components (not shown) to perform its corresponding tasks. Examples of these hardware and software components may include, but not limited to, other required memory, interfaces, buses, Input/Output (I/O) modules or devices, network interfaces, and peripheral devices. In certain embodiments, the computing device 110 is a cloud computer, and the processor 112, the memory 114 and the storage device 116 are shared resources provided over the Internet on-demand.

The processor 112 may be a central processing unit (CPU) which is configured to control operation of the computing device 110. The processor 112 can execute an operating system (OS) or other applications of the computing device 110. In some embodiments, the computing device 110 may have more than one CPU as the processor, such as two CPUs, four CPUs, eight CPUs, or any suitable number of CPUs.

The memory 114 can be a volatile memory, such as the random-access memory (RAM), for storing the data and information during the operation of the computing device 110. In certain embodiments, the memory 114 may be a volatile memory array. In certain embodiments, the computing device 110 may run on more than one memory 114.

The storage device 116 is a non-volatile data storage media for storing the OS (not shown) and other applications of the computing device 110. Examples of the storage device 106 may include non-volatile memory such as flash memory, memory cards, USB drives, hard drives, floppy disks, optical drives, or any other types of data storage devices. In certain embodiments, the computing device 110 may have multiple storage devices 116, which may be identical storage devices or different types of storage devices, and the applications of the computing device 110 may be stored in one or more of the storage devices 116 of the computing device 110. As shown in FIG. 1, the storage device 116 includes a Click-Driven Value Identification (CDVI) application 120 (“Application”). The CDVI application 120 provides a platform for identifying a CDV for a product based on customer clicks on the product.

The CDVI application 120 is configured to identify and update CDV for products provided by an e-commerce platform. In certain embodiments, the updating of CDV is performed regularly, such as monthly. For each time of updating CDV of the products, the CDVI application 120 is configured to retrieve historical click and purchase information in a predetermined time, as well as the product information. In certain embodiments, the predetermined time is one year. In other words, the CDVI application uses a year's history data to calculate the current CDV of the products.

As shown in FIG. 2, the CDVI application 120 includes, among other things, a click collector 122, a product set identification module 124, a profit retrieval module 126, an explanatory power factor derivation module 128, a click CDV determination module 130, and a product CDV identification module 132. In certain embodiments, the CDVI application 120 may include other applications or modules necessary for the operation of the modules 122-132. It should be noted that the modules are each implemented by computer executable codes or instructions, or data table or databases, which collectively forms one application. In certain embodiments, each of the modules may further include sub-modules. Alternatively, some of the modules may be combined as one stack. In other embodiments, certain modules may be implemented as a circuit instead of executable code. In certain embodiments, some of the modules of the CDVI application 120 may be located at a remote computing device, and the modules of the CDVI application 120 in the local computing device 110 communicate with the modules in the remote computing device via a wired or wireless network.

The click collector 122 is configured to, when the CDVI application 120 is initialized or in operation, collect customer clicks on a webpage of a product (also described as customer clicks on a product). In certain embodiments, the click collector 122 retrieves the customer clicks from the customer clicks 200. In certain embodiments, the CDV application 120 is configured to identify or update the current CDV based on the history data in a first predetermined time prior to the current time point, and the click collector 122 is accordingly configured to retrieve the click records in the first predetermined time period prior to the current time. In certain embodiments, the first predetermined time is in a range from half a year to three years, and preferably half a year or one year. Each of the retrieved click records may include the identification of the click, the, the time of the click, the customer performing the click, the product page the click performed on, and the identification of the product on the product page. For example, one of the records may be a customer click i, which is performed by the customer on a product webpage i. Here i is used for the customer click, the webpage the click i is clicked on, and the product on that webpage, for convenience only, where each customer click has a specific corresponding product. In certain embodiments, several clicks may be performed by the same customer on a specific product webpage, but each of the click may be regarded as independent from each other and be used for CDV calculation. In certain embodiments, the click collector 122 retrieves a number of N clicks i₁, i₂, . . . , i_{N}, where N is a positive integer. The click collector 122 is further configured to, after retrieving the customer clicks, send the retrieved customer clicks, either one by one or by batch, to the product set identification module 124. The product set identification module 124 is configured to, upon receiving the clicks form the click collector 122: identify, for each customer click, a set of products associated with the customer click, within a second predetermined time, from the customer purchases 300. In certain embodiments, the second predetermined time is in a range of one day to three months. In certain embodiments, the second predetermined time is in a range of one week to one month. In certain embodiments, the second predetermined time varies according to the product category. In certain embodiments, the second predetermined time is one week (7 days) for certain categories of products, and two weeks (14 days) for some other categories of products. Specifically, after each customer click i, that customer may have purchased one or more products j, i.e., products j₁, j₂, j₃, . . . , jₘ in the following two weeks (within the second predetermined time), and those purchases in the two weeks are termed the product set O(i) corresponding to the customer click i. Here m is the number of purchased products in the second predetermined time associated with the click i, and m is a positive integer or 0. The click i and the purchases of the products j₁, j₂, j₃, . . . , jₘ are by the same customer. Unless specified otherwise, “product j” throughout the description refers to a product which is, in association with the customer click i, purchased by or sold to the customer who performs the “customer click i” as described above. The product set identification module 124 is configured to, for example using the identification of the customer and the time of click in the record of the customer click i, together with the second predetermined time, query the customer purchases 300 to obtain the product set O(i).

In certain embodiments, the product set identification module 124 only retrieves the product associated with the product i. Specifically, the product set identification module 124 limits the products j₁, j₂, j₃, . . . , jₘ to be in the same category or subcategory with the product i, such as under the same third category “soft drinks.” Under this situation, the product set identification module 124 is further configured to obtain the third category information of the product i from the product data 400, and uses the third category information to limit its query against the customer purchases 300 or filter the query against the customer purchases 300, so that all the obtained products j₁, j₂, j₃, . . . , jₘ belong to the same third category as the product i. In certain embodiments, all the purchased products by the customer in the second predetermined time after the click i are included in the set O(i) of products regardless of their category, but the ones that don't belong to the same category or subcategory as the product i are given a very low weight in the following analysis because they may have little association to the click set i. After or in parallel to identifying the set O(i) for the customer click i, the product set identification module 124 is further configured to identify the product set for other customer clicks performed by the same or different customers, and send the plurality of product set O(i) to the profit retrieval module 126 and the explanatory power factor derivation module 128. Each of the product set O(i) corresponds to a customer click.

The profit retrieval module 126 is configured to, upon receiving the plurality of product sets, retrieve the product profits for the products in each of the product sets. In other words, for each product set, such as the product set O(i) containing the products j₁, j₂, j₃, . . . , jₘ, the profit retrieval module 126 is configured to query the customer purchases 300 to retrieve profits wⱼ for each of the products j₁, j₂, j₃, . . . , jₘ. In the same way, the profit retrieval module 126 is configured to obtain profits of products in each of the product sets that corresponding to one of the customer clicks. After obtaining the profits of the associated products to the clicks, the profit retrieval module 126 is further configured to send the obtained profits to the click CDV determination module 130.

The explanatory power factor derivation module 128 is configured to, upon receiving the customer clicks and the product set corresponding to each of the customer clicks, provide an explanatory power factor for each pair of customer click and the corresponding product in the product set. Specifically, for the customer click i and the corresponding product set O(i) containing the products j₁, j₂, j₃, . . . , jₘ, the explanatory power factor derivation module 128 is configured to calculate the explanatory power for the click i and the product j₁, the click i and the product j₂, the click i and the product j₃, . . . , and the click i and the product jₘ. In general, the explanatory power factor between the click i and the product j in association with the customer click i, purchased by or sold to the customer who performs the customer click i within the second predetermined period, is denoted as aᵢⱼ. The explanatory power factor aᵢⱼ of the customer click i may be understood to be used for allocating, to the customer click i, the profit gained from selling the product j.

In certain embodiments, the explanatory power factor aᵢⱼ of the customer click i to the sale of one of the products j (j₁, j₂, j₃, . . . , jₘ) is derived from two important parameters. One is a substitutional effect parameter sᵢⱼ which represents a substitutional effect of using the product j to substitute the product i. The other is a dominance effect parameter dᵢⱼ which represents a dominance effect of the click i in regard to the sale of the product j. The explanatory power factor derivation module 128 is configured to calculate the substitutional effect parameter sᵢⱼ and the dominance effect parameter dᵢⱼ, and then calculate the explanatory power factor aᵢⱼ of the customer click i to the sale of the product j using the equation:

aᵢⱼ=sᵢⱼdᵢⱼ (1)

In an example, assuming that the set O(i) includes m products j₁, j₂, . . . , jₘ, which are sold in association with the customer click i, the explanatory power factor derivation module 128 may obtain the corresponding m explanatory power factor aᵢⱼ₁, aᵢⱼ₂, aᵢⱼ₃, . . . , aᵢⱼₘ of the customer click i to the sales of each product j₁, j₂, . . . , jₘ in the set O(i) according to the equation (1), i.e.,

$${α}_{ij 1} = {s}_{ij 1} {d}_{ij 1} , \\ {α}_{ij 2} = {s}_{ij 2} {d}_{ij 2} , \\ ……$$

$${α}_{ijm} = {s}_{ijm} {d}_{ijm} .$$

It may be appreciated that the corresponding substitutional effect parameters sᵢⱼ₁, sᵢⱼ₂, Sᵢⱼ₃, . . . , sᵢⱼₘ, and the corresponding dominance effect parameters dᵢⱼ₁, dᵢⱼ₂, dᵢⱼ₃, . . . , dᵢⱼₘ may refer to the above general descriptions of sᵢⱼ and dᵢⱼ. The weights of the m products j₁, j₂, . . . , jₘ in the set O(i) which are sold in association with the customer click i are derived, and are used to respectively allocate, to the customer click i, the profits of the m products j₁, j₂, . . . , jₘ. The explanatory power factor derivation module 128 is further configured to, after obtaining the explanatory power factors, send the factors to the click CDV determination module 130.

As shown in FIG. 2, the explanatory power factor derivation module 128 includes two submodules: a substitutional effect determination module 1282 and a dominance effect determination module 1284. The substitutional effect determination module 1282 is configured to calculate and update regularly the substitutional effect parameters between any two related products, and the dominance effect determination module 1284 is configured to determine the dominance effect between two related products at real time, so that the explanatory power factor derivation module 128 can use the corresponding two parameters to calculate the explanatory power factors.

The substitutional effect determination module 1282 is configured to determine the substitutional effect parameter sᵢⱼ based on the sale history of the product i and the sale history of the product j in a third predetermined time prior to the current time, which may be the same as or different from the first predetermined time. In certain embodiments, the third predetermined time is in a range of from a few months to several years, preferably half a year to three years, more preferably half a year or one year, and in one embodiment is half a year. Here the term purchase history and sale history are used interchangeably, where the e-commerce platform sells the products to the customers and the customers purchase the products through the e-commerce platform.

A general explanation of the substitutional effect parameter is as follows. A substitutional effect parameter s_{fg} between a product f and a product g is determined based on sales of the product f and the product g in the third predetermined time period. Here, the use of the characters f and g are intended to illustrate a more general example, in which the product f and the product g may refer to any two products between which a substitutional effect is to be determined, but are not limited to the product i which is clicked by the customer click i and the specific product j in the set O(i), i.e., the products j which are, in association with the customer click i, purchased by or sold to the customer who performs the customer click i in the second predetermined period, as previously described.

In certain embodiments, the substitutional effect determination module 1282 is configured to estimate the substitutional effect parameter s_{f g} by taking a statistical analysis on a purchase history of the product f and g in a third predetermined time, which may be half a year or one year prior to the current time. The third predetermined time may be the same as or different from the first predetermined time. During the third predetermined time, when the product f is out of stock in the warehouse, extra sales of similar products (e.g., product g) due to the out of stock of this product (e.g., product f) are likely observed. Here, it is assumed that the products within the same category at the same level in a predefined product hierarchy are similar. For example, “soft drinks” belongs to the third category under the second category “drinks” which is further under the first category “food & beverages.” In certain embodiments, a product such as the product g is similar to a product such as the product f, where the products g and f are within the same product category such as “soft drinks.” If the extra sale of a the g is statistically significant when the product f is out-of-stock, the substitutional effect determination module 1282 confirms that there is an observable substitutional relationship between the two alternative products. That is, the substitutional effect parameter measures the customer's willingness to substitute between the alternative products. It should be noted that the substitutional relationship is defined uni-directionally, since one may be more willing to use e.g., product g as an alternative for e.g., product f but not the case vice-versa.

In certain embodiments, the substitutional effect parameter sᵢⱼ (or s_{fg} by replacing i and j with f and g) is calculated using an equation (2) based on the historical data in a third predetermined time, such as data in half a year before the current time:

$${s}_{ij} = \frac{\overline{{q}_{ij}} - \overline{{u}_{j}}}{1 + {Σ}_{k} \overline{( {q}_{ik}} - \overline{{u}_{k} )}} , \qquad ( 2 )$$

where q̅ᵢ̅ⱼ̅ is an average sale amount (number of product units sold) of the second product j when the first product i is out of stock, u̅ⱼ̅ represents an average sale amount of the second product j during the third predetermined time (or when the first product i is in stock during the third predetermined time), and thus (q̅ᵢ̅ⱼ̅−u̅ⱼ̅) is related to the additional sales of the product j when product i is out of stock. When i is out of stock, the sale of k different products may be affected, where k is a positive integer corresponding to the number of products that are belong to the same category (such as the third category “soft drink”) as the product i. The same as the above description of q̅ᵢ̅ⱼ̅ and ⱼ̅, q̅ₜ̅ₖ̅, is an average sale amount of one of the k products in the third predetermined time period when the first product i is out of stock, and u̅ₖ̅ is an average sale amount of the one of the k product during the third predetermined time (or when the first product i is in stock during the third predetermined time), and thus (q̅ₜ̅ₖ̅−u̅ₖ̅) is related to the additional sales of the one of the k products when product i is out of stock. The summation of the additional sales of tall he k products in the third predetermined time are then added together. As explained above, k is a group of product in a same third (or third level) category, each of i and j is one of the k product, and (q̅ᵢ̅ⱼ̅−u̅ⱼ̅) is one of the k additional sales of the k products. In certain embodiments, for simplicity of the example, average daily sales are used for the calculation.

In certain embodiments, the substitutional effect parameter sᵢⱼ is calculated using a variation of equation (2) based on the historical data in a third predetermined time, such as data in half a year before the current time:

$${s}_{ij} = \frac{{c}_{1} ( \overline{{q}_{ij}} - \overline{{u}_{j}} )}{{c}_{2} + {Σ}_{k} \overline{( {q}_{ik}} - \overline{{u}_{k} )}} ,$$

where c₁ is a constant in a range of 0.5-10, preferably 1-3, and more preferably 1, c₂ is a constant in a range of 0-10 (greater than 0), preferably 0.5-3, and more preferably 1.

In certain embodiments, the substitutional effect parameter sᵢⱼ is calculated using a variation of equation (2) based on the historical data in a third predetermined time, such as data in half a year before the current time:

$${s}_{ij} = \frac{c ( \overline{{q}_{ij}} - \overline{{u}_{j}} )}{{\overline{u}}_{i} + {Σ}_{k} \overline{( {q}_{ik}} - \overline{{u}_{k} )}} ,$$

where u̅ᵢ̅ represents an average sale amount of the first product i during the third period of time (or when product i is in stock during the third period of time), and c is a constant in a range of 1-10, preferably 1-5, more preferably 1-3, and more preferably is 2.

In certain embodiments, the monthly sale amounts in the formula may be replaced by monthly sale values. In certain embodiments, the substitutional effect determination module 1282 is configured to obtain the sales and optionally sale price data from the customer purchases 300. In certain embodiments, the value of the substitutional effect parameter sᵢⱼ is between 0 and 1. In certain embodiments, when the product i has never out of stock in the previous half a year, the substitutional effect parameter sᵢⱼ is defined as 0, that is, no substitutional effect is observed for the products i and one of the k products in the past half a year. In certain embodiments, the e-commerce platform has several regional distribution centers, and one of the regional distribution centers (when no substitutional effect is observed for the products i and the one of the k products) may obtain the substitutional effect value for the products i and the one of the k products from another one of the regional distribution center.

The dominance effect determination module 1284 is configured to calculate the dominance effect parameter dᵢⱼ at real time, which represents a dominance effect of the click i in regard to the selling of the product j in the set O(i). Specifically, the dominance effect determination module 1284 retrieves information from the customer clicks 200 and the customer purchases 300 by: locating the purchase of the product j by the customer making the click i, and find all the clicks by the customer during a fourth predetermined time before the purchase of the product j. The fourth predetermined time may be the same as or different from the third predetermined time, and in certain embodiments, the fourth predetermined time is in a range of a few days to a few weeks, and preferably two weeks or one week. In one embodiment, the fourth predetermined time is two weeks. Generally, there are multiple intermediate clicks in the two week time frame, and some intermediate clicks may be performed earlier than the click i (or clicked of the product i) and some intermediate clicks may be performed later than the click i in that two weeks. The intermediate clicks correspond to multiple intermediate products. The product i and the intermediate products each have a sale price. A ratio of the sale price of the product i to the total sale prices of the product i and the intermediate products indicates the contribution of the product i to the selling of the product j, and is regarded as the dominance effect parameter.

A general explanation of the dominance effect parameter is described in detail. A dominance effect parameter dᵢⱼ represent a dominance effect of the product i among the products clicked by the customer clicks prior to selling the product j. In certain embodiments, the dominance effect is measured by a (e.g. real-time) sale prices of the products, since it is generally considered that a product with a higher sale price has a dominant effect among its related products. For example, a ‘mobile phone,’ which is of a higher sale price, is considered to have a dominant effect among e.g. a ‘phone case,’ a ‘charging line,’ etc., which are of lower sale prices and are generally sold in association with the ‘mobile phone.’ Thus, the dominance effect parameter may be considered to address an importance of a high value product in a purchasing decision. Accordingly, the dominance effect parameter dᵢⱼ may be calculated as a ratio of the sale price of the product i to a sum of prices of the products clicked by the customer after the click i and prior to the sale of the product j.

In certain embodiments, the dominance effect determination module 1284 is configured to determine the dominance effect parameter dᵢⱼ which represents the dominance effect of the product i among the products clicked by the customer prior to the sale of the product j within the fourth predetermined time. In certain embodiments, the dominance effect parameter dᵢⱼ is calculated using an equation (3):

$${d}_{ij} = \frac{{r}_{i}}{{Σ}_{q ∈ C ( j )} {r}_{q}} , \qquad ( 3 )$$

where rᵢ is a price of the product i clicked by the customer click i, O(j) is a set of products clicked by the customer prior to the sale of the product j in the given time (the fourth predetermined time), q is indexed for the products in the set O(j) and is a positive integer, and r_{q} is a price of one of the q products. In certain embodiments, the value of the dominance effect parameter dᵢⱼ is between 0 and 1.

In certain embodiments, the current substitutional effect parameter sᵢⱼ and the real time value of the dominance effect parameter dᵢⱼ are available to the explanatory power factor derivation module 128 to calculate the explanatory power factor. As described above, the explanatory power factor derivation module 128 is further configured to send the explanatory power factor to the click CDV determination module 130, or alternatively the click CDV determination module 130 is configured to retrieve the corresponding explanatory power factors from the explanatory power factor derivation module 128.

The click CDV determination module 130 is configured to, upon receiving the profits from the profit retrieval module 126 and the explanatory power factor from the explanatory power factor derivation module 128, calculate a click CDV vᵢ for the customer click i based on the profits of the products which are sold in association with the customer click i in the second predetermined time and the explanatory power factor between the product or click i and the sold products based on the sales of the products i and the sold products in the first predetermined time. The sold products are the products in the set O(i). In certain embodiments, the click CDV determination module 130 is configured to calculate the click CDV vᵢ for the customer click i using an equation (4):

vᵢ=Σ_{jϵO(i)}aᵢⱼwⱼ (4)

In connection with the example as described above, the CDV vᵢ for the customer click i is a weighted sum of the profits of the m products j₁, j₂, . . . , jₘ in the set O(i) which are sold in association with the customer click i, i.e.,

vᵢ=aᵢⱼ₁wⱼ₁+aᵢⱼ₂wⱼ₂+ . . . +aᵢⱼₘwⱼₘ=sᵢⱼ₁dᵢⱼ₁wⱼ₁sᵢⱼ₂dᵢⱼ₂wⱼ₂+ . . . + s_{ijN}dᵢⱼₘwⱼ₁ₘ.

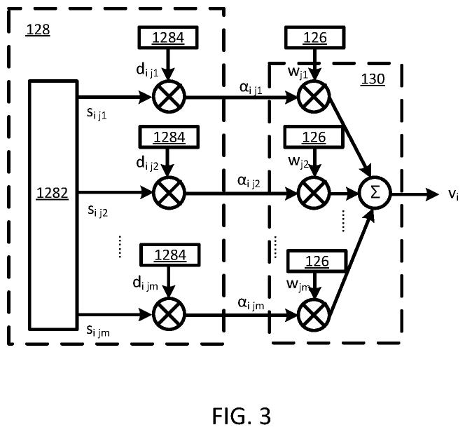

In certain embodiments, such a process of determining a CDV vᵢ for a single customer click i is schematically depicted in FIG. 3. Although in FIG. 3, several dominance effect determination modules 1284 are shown separately, they may be embodied as a single dominance effect determination module 1284, by which dᵢⱼ₁, dᵢⱼ₂, . . . , dᵢⱼₘ may be determined separately. Similarly, although several profit retrieval modules 126 in FIG. 3 are shown separately, they may be embodied as a single profit retrieval module 126, by which wⱼ₁, wⱼ₂, . . . , wⱼₘ may be retrieved separately. The process of determining the CDV vᵢ for the single customer click i as shown in FIG. 3 may refer to the above description for details, and thus will not be described here for simplicity. Based on the above, a value, i.e., CDV, of a single customer click on a product may be determined. By the same method, the click CDV determination module 130 is configured to calculate the click CDVs for the different clicks of one customer and the customer clicks from different customers. The click CDV determination module 130 is further configured to send those calculated click CDVs to the product CDV identification module 132.

The product CDV identification module 132 is configured to, upon receiving the calculated click CDVs from the click CDV determination module 130, calculate a CDV for each of the products. Generally, there are more than one customer click on a product. Therefore, a CDV value of the product, which is also referred to as product CDV, may be identified by taking CDVs for all of the customer clicks on that product into account. In certain embodiments, the product CDV identification module 132 is configured to identify the product CDV by taking an average of the click CDVs from different customers, where all the customer clicks are performed on that product.

In an example, assuming that there are N customer clicks on the product i, denoted as customer clicks i₁, i₂, . . . , i_{N}, the product CDV identification module 132 is configured to calculate the product CDV for the product, denoted as pᵢ, using an equation (5):

$${p}_{i} = \frac{{Σ}_{N} Vi}{N} , \qquad ( 5 )$$

where vᵢ represents the N number of click CDVs for the N number of customer clicks on the product i. Kindly note for different product i, the number of customer clicks N is likely different, and for the same product i, each click is likely to have a different m.

In certain embodiments, as described above, the calculation of vᵢ, aᵢⱼ, and sᵢⱼ are respectively performed using different dataset in different time period, but they are all calculated in regard to the same product i and j. In certain embodiments, product CDVs for all the product are updated monthly by calculating all the customer-related clicking and purchasing history in the past year.

In certain embodiments, the substitutional effect parameter sᵢⱼ is updated at a relatively long period, e.g. monthly, and each updates uses the historical data in the past half a year; while the dominance effect parameter dᵢⱼ is updated at a relatively short period, e.g., in real time, using the prices of the products corresponding to the intermediate clicks, and the price of the product i.

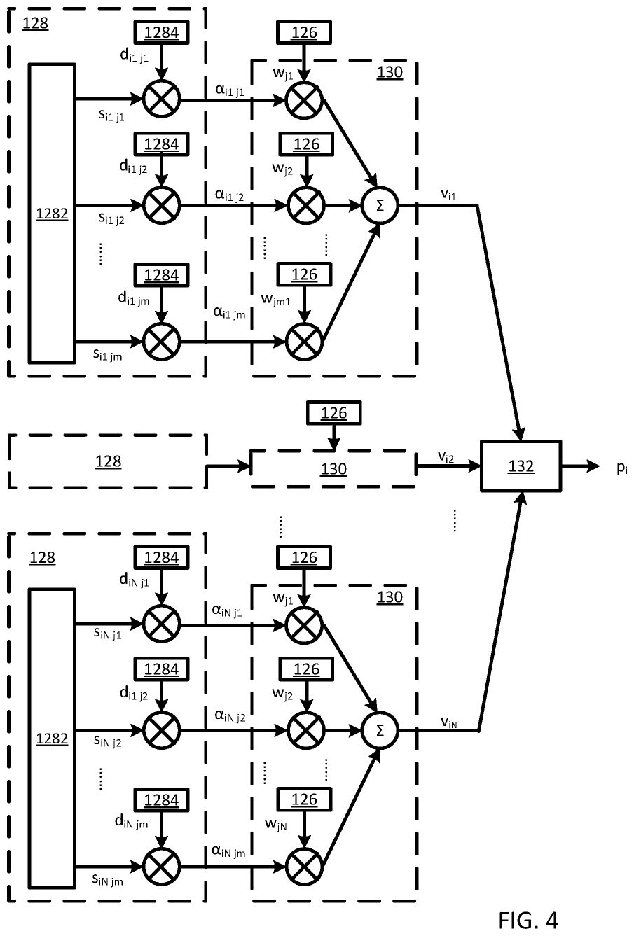

In certain embodiments, a complete process of identifying a CDV pᵢ for a product i is schematically depicted in FIG. 4, in which the process of determining the respective outputs vᵢ from the click CDV determination module 130 is completely identical with that as shown in FIG. 3. Basically, the click CDV determination module 130 determines a click CDV for each of the N customer clicks on the same product i. For the first customer click i, and the purchase of the product j by the same customer, there are m number of intermediate products purchased by that customer between the customer click i and the purchase of the product j. Each pair of the product i and one of the m intermediate products has corresponding substitutional effect parameter and dominance effect parameter, the arithmetic product of the parameters is the corresponding weight for the profit of the intermediate product. Each intermediate product thus has a contribution by timing its weight with its profit. A click CDV is calculated by averaging the contributions of the m intermediate products, i.e., vᵢ₁.

As shown in FIG. 4, by the similar calculation, the click CDV for the Nₜₕ customer click (on the same product) is also calculated, where the click CDV v_{iN} is calculated by averaging the contributions of the m intermediate products. Kindly note the number of m intermediate products for the customer clicks 1 to N are for convenience only, and the numbers m for the customer clicks are independent from each other, and are likely different positive integers.

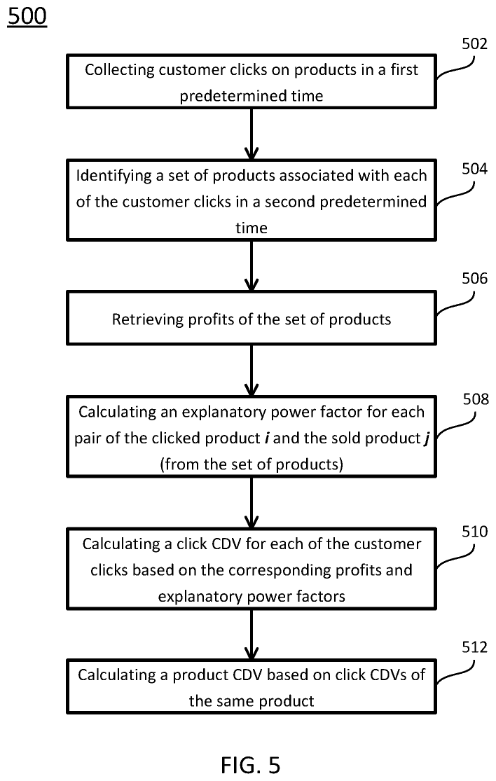

FIG. 5 depicts a method 500 of identifying a CDV of a product according to certain embodiments of the present disclosure. In certain embodiments, the method 500 is implemented by the computing device shown in FIG. 2. It should be particularly noted that, unless otherwise stated in the present disclosure, the steps of the method may be arranged in a different sequential order, and are thus not limited to the sequential order as shown in FIG. 5. Some detailed description which has been discussed previously will be omitted here for simplicity.

As shown in FIG. 5, at procedure 502, the click collector 122 collects customer clicks on products from the customer clicks 200 during a first predetermined time. The products may include all of a significant portion of the products provided by an e-commerce platform, and the first predetermined time may be about half a year or one year. For each product i, there may be multiple clicks coming from different customers. After the collection or retrieval, the click collector 122 sends the customer clicks on products to the product set identification module 124.

At procedure 504, upon receiving the customer clicks, the product set identification module 124 identifies, for each of the customer click i, a set of associated products O(i) from the customer purchases 300 in a second predetermined time. In certain embodiments, the product set identification module 124 defines that the set of products are associated with the click i or product i when the set of products and the product i are under the same third category and has been purchased by or sold to the same customer after the click i and during the second predetermined time. In certain embodiments, the second predetermined time may be one week or two weeks. The set of associated products O(i) for the click i, for example, includes m number of products j₁, j₂, j₃, . . . , jₘ. The product set identification module 124 then sends the identified set of products O(i) to the profit retrieval module 126 and the explanatory power factor derivation module 128.

At procedure 506, upon receiving the set of products O(i), the profit retrieval module 126 retrieves profit of the sale of the products j₁, j₂, j₃, . . . , jₘ from the database—customer purchases 300 corresponding to the sale. The profit for a sale of a product j is termed wⱼ, the profit retrieval module 126 then sends the profits to the click CDV determination module 130.

At procedure 508, upon receiving the set of products O(i), the explanatory power factor derivation module 128 calculate an explanatory power factor for each pair of the product i and one of the product products j₁, j₂, j₃, . . . , jₘ. Specifically, the explanatory power factor derivation module 128 retrieves a current substitute effect parameter sᵢⱼ and a current dominance effect parameter dᵢⱼ, and calculates the factor aᵢⱼ of the customer click i to the sale of the product j using the formula (1): aᵢⱼ=sᵢⱼdᵢⱼ. Then the explanatory power factor derivation module 128 sends the explanatory power factors for each pair of the clicked product and the associated sold products to the click CDV determination module 130.

At procedure 510, upon receiving the profits of the set of products O(i) and the explanatory power factors, the click CDV determination module 130 calculates the click CDV for each of the click i using the formula: vᵢ=Σ_{jϵO(i)}aᵢⱼwⱼ. In certain embodiments, the click CDV for the customer click is a measure of benefit gained from the customer click that contributes to the profits of the products which are sold in association with the customer click. After calculating the click CDVs, the click CDV determination module 130 then sends the click CDVs to the product CDV identification module 132.

At procedure 512, upon receiving the click CDVs, the product CDV identification module 132 calculates the product CDV using the click CDVs of the same product by different customers. Specifically, there are multiple clicks on a same product i or the webpage of the product i by different customers, each customer click has a corresponding click CDV, and the click CDVs on the same product i are averaged to obtain the product CDV. The product CDV is calculated using the formula (5)

$${p}_{i} = \frac{{Σ}_{N} Vi}{N} .$$

Following the same process, the product CDV identification module 132 calculates product CDVs for all or a significant portion of the products provided by the e-commerce platform. In certain embodiments, those product CDVs are updated monthly to reflect the change of the values the product contribute to the platform. Those regularly updated product CDV is useful in assisting other types of project in the e-commerce platform, such as inventory planning and control, and marketing planning, etc.

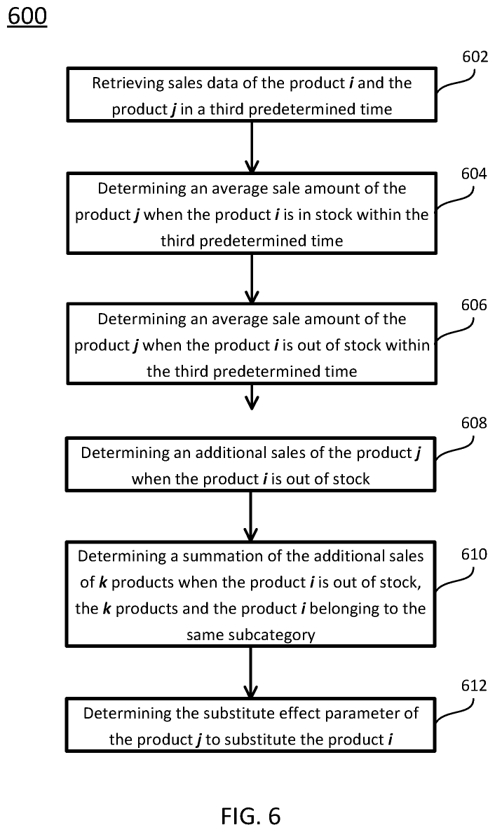

FIG. 6 schematically depicts a method of determining a substitutional effect parameter according to certain embodiments of the present disclosure. Using a product i and a product j as example, the substitutional effect parameter sᵢⱼ represents the degree of influence from product j to the product i. In certain embodiments, the method 600 is implemented by the computing device shown in FIG. 2. It should be particularly noted that, unless otherwise stated in the present disclosure, the steps of the method may be arranged in a different sequential order, and are thus not limited to the sequential order as shown in FIG. 6. Some detailed description which has been discussed previously will be omitted here for simplicity.

As shown in FIG. 6, at procedure 602, the substitutional effect determination module 1282 retrieves sales data of the product i and a product j (one of j₁, j₂, j₃, . . . , jₘ) from the customer purchase 300 in a third predetermined time. The third predetermined time may be half a year, one year, or two or three years, and preferably half a year. The third predetermined time is longer than the second predetermined time, and may be the same or different from the first predetermined time. It is preferably that during one or more periods or time windows within the third predetermined time, the product i is out of stock while the product j is still available.

At procedure 604, the substitutional effect determination module 1282 determines the average sale amount u̅ⱼ̅ of the product j during the third predetermined time. In certain embodiments, the average sale amount u̅ⱼ̅ of the product j is calculated by adding all the sale amount of the product j during the third predetermined time and dividing the total amount by the third determined time to obtain, for example the average sale amount t u̅ⱼ̅ with a unit of number of items/day. In certain embodiments, the average sale amount u̅ⱼ̅ of the product j is calculated by adding all the sale amount of the product j during the third predetermined time and dividing the total amount by the days the product j is in stock (during the third determined time). In certain embodiments, the average sale amount u̅ⱼ̅ of the product j is calculated by adding all the sale amount of the product j when the product i is in stock and dividing the total amount by the days the product j is in stock and the product i is in stock (during the third determined time). Thus, in certain embodiments, the time for determining the average sale amount u̅ⱼ̅ of the product j is part of the third predetermined time.

At procedure 606, the substitutional effect determination module 1282 determines the average sale amount q̅ᵢ̅ⱼ̅ of the product j when the product i is out of stock within the third predetermined time. That is, the time for determining the average sale amount q̅ᵢ̅ⱼ̅ of the product j is part of the third predetermined time.

At procedure 608, the substitutional effect determine module 1282 calculates an additional sales of the product j when the product i is out of stock by subtracting u̅ⱼ̅ from q̅ᵢ̅ⱼ̅, that is, (q̅ᵢ̅ⱼ̅−u̅ⱼ̅). In certain embodiments, due to the different calculations of the u̅ⱼ̅, the calculated value may not be exactly the averaged additional sales, but a value related to the additional sales of the product j.

At procedure 610, by repeating the procedures 604-608 for each of the product k in the same category (such as the third subcategory) as the product i, additional sales of each of the product k in the third predetermined time when the product i is out of stock is calculated, and the summation of those k additional sales are calculated, that is, Σₖ(q̅ₜ̅ₖ̅−u̅ₖ̅). Kindly note (q̅ᵢ̅ⱼ̅−u̅ⱼ̅) is one of the Σₖ(q̅ₜ̅ₖ̅−u̅ₖ̅).

At procedure 612, after obtaining the above obtained (q̅ᵢ̅ⱼ̅−u̅ⱼ̅) and Σₖ(q̅ᵢ̅ₖ̅−u̅ₖ̅), the substitutional effect determination module 1282 then calculates the substitutional effect parameter using the formula (2):

$${s}_{ij} = \frac{\overline{{q}_{ij}} - \overline{{u}_{j}}}{1 + {Σ}_{k} \overline{( {q}_{ik}} - \overline{{u}_{k} )}} .$$

In certain embodiment, the substitutional effect parameter is a number between 0 and 1.

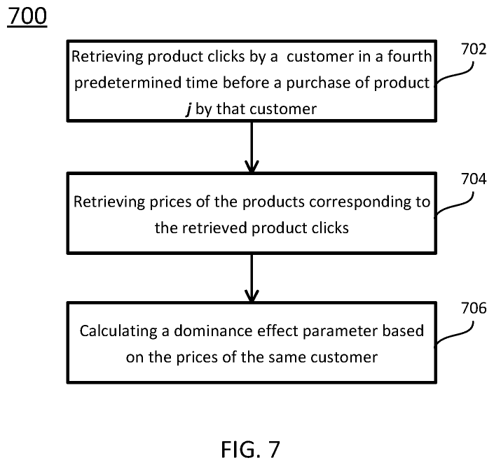

In certain embodiments, the substitutional effect determination module 1282 may also calculate the substitutional effect parameter sᵢⱼ in alternative ways, such as using the formula

$${s}_{ij} = \frac{{c}_{1} ( \overline{{q}_{ij}} - \overline{{u}_{j}} )}{{c}_{2} + {Σ}_{k} \overline{( {q}_{ik}} - \overline{{u}_{k} )}} ,$$

where c₁ is a constant in a range of 0.5-10, preferably 1-3, and more preferably 1, c₂ is a constant greater than 0 and less than 10, preferably 0.5-3, and more preferably 1; or calculate the substitutional effect parameter sᵢⱼ using the formula

$${s}_{ij} = \frac{c ( \overline{{q}_{ij}} - \overline{{u}_{j}} )}{{\overline{u}}_{i} + {Σ}_{k} \overline{( {q}_{ik}} - \overline{{u}_{k} )}} ,$$

where u̅ᵢ̅ represents an average sale amount of the first product i during the third period of time (or when product i is in stock during the third period of time), and c is a constant in a range of 1-10, preferably 1-5, more preferably 1-3, and more preferably is 2. When different formula are used for calculation, the substitutional effect determination module 1282 may perform the above steps 604-612 with variations accordingly. FIG. 7 schematically depicts a method of determining a dominance effect parameter according to certain embodiments of the present disclosure. In certain embodiments, the method 700 is implemented by the computing device shown in FIG. 2. It should be particularly noted that, unless otherwise stated in the present disclosure, the steps of the method may be arranged in a different sequential order, and are thus not limited to the sequential order as shown in FIG. 7. Some detailed description which has been discussed previously will be omitted here for simplicity.

As shown in FIG. 7, at procedure 702, the dominance effect determination module 1284 retrieves customer click data from the customer clicks 200 based on the purchase of a product j (one selected from j₁, j₂, j₃, . . . , jₘ) and a customer click i before the purchase of the product j. Specifically, the dominance effect determination module 1284 retrieves, for each purchase of the product j by the customer, clicks by that customer in fourth predetermined time before the purchase of the product j, the retrieved clicks here includes the customer click i. In certain embodiments, the fourth predetermined time is in a range of from one week to one month. In one embodiment, the fourth predetermined time is two weeks. Kindly note each of retrieved clicks corresponds to a product, and that corresponding product is associated with the product j. In certain embodiments, the association means the corresponding product and the product j belong to the same third category. In other words, if a click during the fourth predetermined time by the customer corresponds to a product that is not in the same product category or subcategory as the product j, that click is not retrieved. The products corresponding to the retrieved clicks in the fourth predetermined time before the purchase of the product j form a set of products O(j). In certain embodiments, the set of products O(j) is termed dominance data set for convenience.

At procedure 704, for each dominance dataset, the dominance effect determination module 1284 retrieves product sale prices from the product data 400 or the customer purchases 300, for the products in O(j). Each product in O(j) is termed a product q, which has a sale price r_{q}, and the product i has a sale price rᵢ.

At procedure 706, the dominance effect determination module 1284 determines the dominance effect parameter using the formula (3),

$${d}_{ij} = \frac{{r}_{i}}{{Σ}_{q ∈ C ( j )} {r}_{q}} .$$

In practice, the identified CDV for a product may have a plurality of usages. In certain embodiments, the system for identifying a CDV for a product based on customer clicks on the product using the computing device according to the present disclosure may be connected to an IPCS, so that the IPCS may decide, based on the identified CDV for the product output from the system for identifying the CDV for the product, whether to carry the product and how many inventories to carry for the product if it is decided to carry the product.

For example, a CDV for a product ‘haoqi diaper XL 44’ is 1.9 RMB. This indicates each customer click on the webpage of the product will potentially generate 1.9 RMB profit to the company because it drives the sales of other products. For IPCS, it will add this 1.9 RMB to the in-stock value of the product, which could further suggest holding more stock of this product in the warehouse if the value is larger comparing to CDV values of other products.

In certain embodiments, the system for identifying a CDV for a product based on customer clicks on the product using the computing device according to the present disclosure may be connected to an MPS, so that the MPS may decide, based on the identified CDV for the product, how much to spend on acquiring a customer. If the product CDV is high, the e-commerce platform may charge more to a third company who wants to have an advertisement linked to that product. Still taking a CDV for a product ‘haoqi diaper XL 44’ being 1.9 RMB as an example, for the MPS, it may send 1.9 RMB as a reference sale price to an advertisement bidding system.

In a further aspect, the present invention is related to a non-transitory computer readable medium storing computer executable code. The code, when executed at a processer 112 of the computing device 110, may perform the method 500-700 as described above. In certain embodiments, the non-transitory computer readable medium may include, but not limited to, any physical or virtual storage media. In certain embodiments, the non-transitory computer readable medium may be implemented as the storage device 116 of the computing device 110 as shown in FIG. 2.

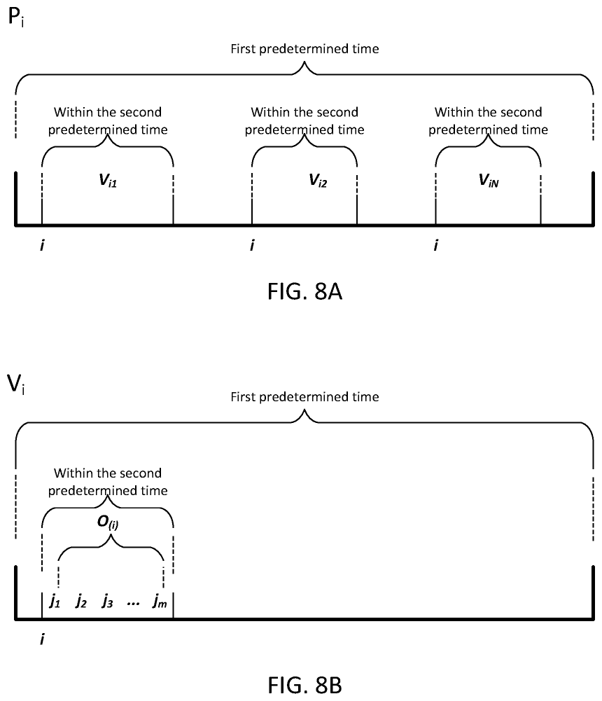

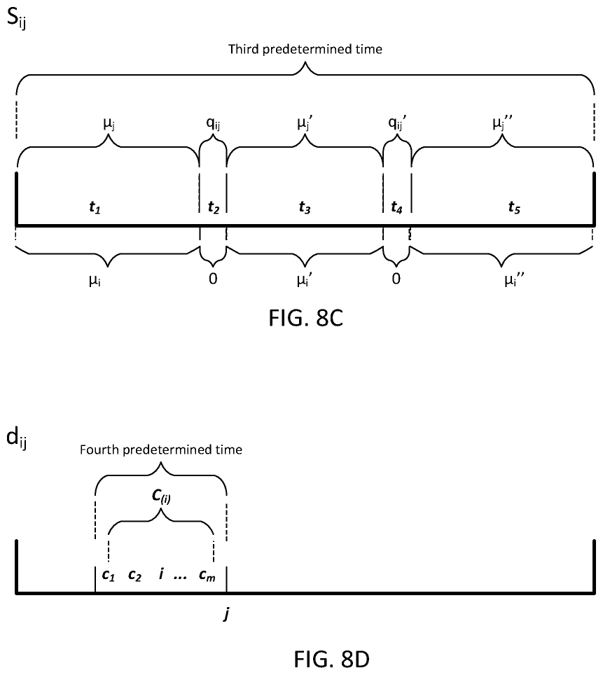

FIG. 8A-8D schematically depict an example according to certain embodiments of the present disclosure. FIG. 8A shows calculation of one of the product CDV in the first predetermined time. As shown in FIG. 8A, there are N number of clicks of the product i by different customers (or in certain embodiments, some of the click CDVs belong to the same customer when the customer clicks the same product several times) in the first predetermined time, where each click of product i has corresponding purchases of products within a second period of time. Kindly note the click i having no purchases of products within the second period of time doesn't count. Further, although the time frames for each click i and its corresponding second period of time is shown separated from each other, they may actually overlap with each other. Furthermore, each click i and the purchases of products within the second period of time after the click i is performed by the same one of the customers. Each click i and the corresponding purchases of product has a corresponding click CDV, and there are N number of click CDVs vᵢ₁, vᵢ₂, . . . , v_{iN}. In certain embodiments, the product CDV pᵢ is an arithmetic average of the click CDVs vᵢ₁, vᵢ₂, . . . , v_{iN} in the first predetermined time. The first predetermined time may be in a range of half a year to three years, and preferably half a year or one year, and in certain embodiments is half a year. The second predetermined time is in a range of one week, two weeks, a month, or a quarter of a year, preferably one week or two weeks depending on the category of the product. In certain embodiments, the first predetermined time is half a year and the second predetermined time is two weeks.

FIG. 8B shows, in general, calculation of one of the click CDVs in FIG. 8A. As shown in FIG. 8B, within the second period after the click i by a customer, there are sales of the products j₁ to jₘ by the same customer. The click CDV of that click i can be calculated using the formula (4): vᵢ=Σ_{jϵO(i)}aᵢⱼwⱼ, where the set O(i) includes the product j₁ to jₘ, the explanatory power factor aᵢⱼ are calculated using formula (1) for each pair of i-j₁, i-j₂, . . . , i-jₘ, and the profit wⱼ are respectively the profit of selling the product j₁ to jₘ. Kindly note for each of the click i by a specific customer, there is a specific products O(i) by that customer. Therefore, each of the click i in FIG. 8A have its own corresponding set of products O(i).

Further, the product i and the product in the sets of the products O(i) are products in the same subcategory, such as the third category as described above.

FIG. 8C shows calculation of the substitutional effect parameter sᵢⱼ in a third predetermined time for the product i and the product j. The third period of time may be the same or different from the first predetermined time. In certain embodiments, the third predetermined time is in a range of half a year to three years, and preferably half a year or one year. In certain embodiments, the third predetermined time is half a year. In certain embodiments, the substitutional effect parameter sᵢⱼ is updated, for example monthly, using the data half a year prior to the update time (current time). As shown in FIG. 8C, in the third predetermined time, such as half a year, the product i is in stock during the time t₁, t₃ and t₅, and is out of stock in the time t₂ and t₄. The average sale amount (such as number of product unit sold daily) of product i in the time t₁ is μᵢ, the sale amount of product i in the time t₃ is μᵢ′, and the sale amount of product i in the time t₅ is μᵢ″. The sale amount of product j in the time t₁ is μⱼ, the sale amount of product j in the time t₃ is μⱼ′, and the sale amount of product j in the time t₅ is μⱼ″. The sale amount of product j in the time t₂ is qᵢⱼ, and the sale amount of product j in the time t₄ is μⱼ″. The parameter sᵢⱼ is then calculated using the formula (2):

$${s}_{ij} = \frac{\overline{{q}_{ij}} - \overline{{u}_{j}}}{1 + {Σ}_{k} \overline{( {q}_{ik}} - \overline{{u}_{k} )}} ,$$

where q̅ᵢ̅ⱼ̅ is the average of qᵢⱼ and qᵢⱼ′, or the average of qᵢⱼ, qᵢⱼ′, μⱼ, μⱼ′, and μⱼ″; u̅ⱼ̅ is the average of μⱼ, μⱼ′, and μⱼ″; (q̅ᵢ̅ⱼ̅−u̅ⱼ̅) relates to the additional sales of the product j when the product i is out of stock; k is the number of products in the same category or subcategory as the product i, and for each of the k number of products, the corresponding (q̅ₜ̅ₖ̅−u̅ₖ̅) is calculated the same way as the calculation of (q̅ᵢ̅ⱼ̅−u̅ⱼ̅). In certain embodiments, as described above, formula

$${s}_{ij} = \frac{{c}_{1} ( \overline{{q}_{ij}} - \overline{{u}_{j}} )}{{c}_{2} + {Σ}_{k} \overline{( {q}_{ik}} - \overline{{u}_{k} )}} or {s}_{ij} = \frac{c ( \overline{{q}_{ij}} - \overline{{u}_{j}} )}{{\overline{u}}_{i} + {Σ}_{k} \overline{( {q}_{ik}} - \overline{{u}_{k} )}}$$

may also be used as alternative ways to calculate the substitute effect parameter sᵢⱼ.

FIG. 8D shows calculation of the dominance effect parameter dᵢⱼ for the click i and the purchase of the product j pair, where each of the click i-purchase j pair are one of the i-jᵢ pair, i-j₂ pair, . . . , i-jₘ. The fourth period of time may be the same as or different from the second predetermined time. In certain embodiments, the fourth predetermined time is in a range of one day to one month, and preferably one week or two weeks. As shown in FIG. 8D, in the fourth predetermined time period before the purchase of the product j, there are a plurality of, such as m number of clicks c₁, c₂, c3 to cₘ by the same customer. The dominance effect parameter dᵢⱼ is calculated using the formula (3):

$${d}_{ij} = \frac{{r}_{i}}{{Σ}_{k ∈ C ( j )} {r}_{k}} ,$$

where rᵢ is the sale price of the product i corresponding to click i, O(j) is a set of products corresponding to the clicks c₁, c₂, c₃ to cₘ₁ (including click i), and rₖ is the sale price of the set of products in O(j), and Σ_{kϵO(j)}rₖ is the sum of the sale prices of the products in O(j). By the same method as described above, the dominance effect parameter dᵢⱼ for each of the i-j₁ pair, i-j₂ pair, . . . , i-jₘ (for example in FIG. 8B) can be calculated. Kindly note the calculation of each click CDVs vᵢ shown in FIG. 8A or FIG. 8B is based on the intermediate purchases of the product j₁ to jₘ, while the calculation of the dominance effect parameter of dᵢⱼ is based on the intermediate clicks c₁ to cₘ, and the number m in the purchase of the product j₁ to jₘ and the number m in the clicks of the product c₁ to cₘ are generally different from each other.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for calculating a product Click-Driven Value (CDV) of a first product, the method comprising:
receiving, by a computing device, a plurality of customer clicks on the first product;
determining, by the computing device, a click CDV for each of the customer clicks based on profit of a plurality of second products sold after the customer click and associated with the customer click; and
calculating, by the computing device, the product CDV of the first product by averaging the click CDVs for all of the customer clicks on the first product.

2. The method of claim 1, wherein the customer clicks on the first product are performed within a first predetermined time, and the step of determining the click CDV comprises:
identifying a set O(i) of the second products j associated with a customer click i of the customer clicks, wherein each of the second products j in the set O(i) is purchased by the customer performing the customer click i within a second predetermined time after the customer click i;
retrieving a profit wⱼ for selling each of the second products j in the set O(i);
deriving, for each product j in the set O(i), an explanatory power factor aᵢⱼ according to click history and sales history of the first product, the second products, and products associated with the first and second products; and
calculating the click CDV vᵢ for the customer click i by:
vᵢ=Σ_{jϵO(i)}aᵢⱼwⱼ,
wherein i is an index for the customer click i, j is an index for the second products in the set O(i), and i and j are positive integers.

3. The method of claim 2, wherein for each product j in the set O(i), the explanatory power factor aᵢⱼ is derived by:
aᵢⱼ=sᵢⱼdᵢⱼ,
wherein sᵢⱼ is a substitutional effect parameter representing a substitutional effect of using the second product j to substitute the first product i; and
wherein dᵢⱼ is a dominance effect parameter representing a dominance effect of the first product i to sale of the second product j.

4. The method of claim 3, wherein the substitutional effect parameter sᵢⱼ is determined by:
$${s}_{ij} = \frac{\overline{{q}_{ij}} - \overline{{u}_{j}}}{1 + {Σ}_{k} \overline{( {q}_{ik}} - \overline{{u}_{k} )}} ,$$
wherein q̅ᵢ̅ⱼ̅ represents an average sale amount of the second product j when the first product i is out of stock in a third predetermined time, u̅ⱼ̅ represents an average sale amount of the second product j in the third predetermined time, q̅ₜ̅ₖ̅ is an average sale amount of one of k products when the first product i is out of stock in the third predetermined time, u̅ₖ̅ represents an average sale amount of the one of the k products in the third predetermined time, k is a positive integer, and the k products and the product t i belong to a same product category.

5. The method of claim 4, wherein the dominance effect parameter dᵢⱼ is determined by:
$${d}_{ij} = \frac{{r}_{i}}{{Σ}_{q ∈ C ( j )} {r}_{q}} ,$$
wherein rᵢ is a sale price of the first product i, O(j) is a set of products clicked within a fourth predetermined time prior to the sale of the second product j, q is an index for the products in the set O(j) and is a positive integer, and r_{q} is a sale price of the product q.

6. The method of claim 5, wherein the first predetermined time is half a year, the second predetermined time is two weeks, the third predetermined time is half a year, and the fourth predetermined time is two weeks.

7. The method of claim 3, wherein the substitutional effect parameter sᵢⱼ is determined by:
$${s}_{ij} = \frac{{c}_{1} ( \overline{{q}_{ij}} - \overline{{u}_{j}} )}{{c}_{2} + {Σ}_{k} \overline{( {q}_{ik}} - \overline{{u}_{k} )}} ,$$
wherein c₁ and c₂ are constants, represents an average sale amount of the second product j when the first product i is out of stock in a third predetermined time, u̅ⱼ̅ represents an average sale amount of the second product j in the third predetermined time, q̅ᵢ̅ₖ̅ is an average sale amount of one of k products when the first product i is out of stock in the third predetermined time, u̅ₖ̅ represents an average sale amount of the one of the k products in the third predetermined time, k is a positive integer, and the k products and the product t i belong to a same product category.

8. The method of claim 7, wherein c₁ is in a range of 1-3, c₂ is in a range of 0.5-3, the first predetermined time is half a year, the second predetermined time is two weeks, and the third predetermined time is half a year.

9. The method of claim 3, wherein the substitutional effect parameter sᵢⱼ is determined by:
$${s}_{ij} = \frac{c ( \overline{{q}_{ij}} - \overline{{u}_{j}} )}{{\overline{u}}_{i} + {Σ}_{k} \overline{( {q}_{ik}} - \overline{{u}_{k} )}} ,$$
wherein c is a constant, q̅ᵢ̅ⱼ̅ represents an average sale amount of the second product j when the first product i is out of stock in a third predetermined time, u̅ⱼ̅ represents an average sale amount of the second product j in the third predetermined time, u̅ⱼ̅ represents an average sale amount of the first product i during the third period of time, q̅ᵢ̅ₖ̅ is an average sale amount of one of k products when the first product i is out of stock in the third predetermined time, u̅ₖ̅ represents an average sale amount of the one of the k products in the third predetermined time, k is a positive integer, and the k products and the product i belong to a same product category.

10. The method of claim 9, wherein c is in a range of 1-3, the first predetermined time is half a year, the second predetermined time is two weeks, and the third predetermined time is half a year.

11. The method of claim 1, further comprising deciding whether to carry the first product and an amount of the first product to carry, by an Inventory Planning and Control System (IPCS) in communication with the computing device, based on the calculated product CDV for the first product.

12. The method of claim 1, further comprising deciding how much to spend on acquiring a customer, by a Marketing Planning System (MPS) in communication with the computing device, based on the calculated product CDV for the first product.

13. A system for calculating a product Click-Driven Value (CDV) of a first product, the system comprising a computing device, the computing device comprising a processor and a storage device storing computer executable code, wherein the computer executable code, when executed at the processor, is configured to:
receive a plurality of customer clicks on the first product;
determine a click CDV for each of the customer clicks based on profit of a plurality of second products sold after the customer click and associated with the customer click; and
calculate the product CDV of the first product by averaging the click CDVs for all of the customer clicks on the first product.

14. The system of claim 13, wherein the customer clicks on the first product are performed within a first predetermined time, and the computer executable code is configured to determine the click CDV by:
identifying a set O(i) of the second products j association with a customer click i of the customer clicks, wherein each of the second product j in the set O(i) is purchased by the customer performing the customer click i within a second predetermined time after the customer click i;
retrieving a profit wⱼ for selling each of the second products j in the set O(i);
deriving, for each product j in the set O(i), an explanatory power factor aᵢⱼ according to click history and sales history of the first product, the second products, and products associated with the first and second products; and
calculating the click CDV vᵢ for the customer click i by:
vᵢ=Σ_{jϵO(i)}aᵢⱼwⱼ,
wherein i is an index for the customer click i, j is an index for the second products in the set O(i), and i and j are positive integers.

15. The system of claim 14, wherein the computer executable code is configured to, for each product j in the set O(i), derive the explanatory power factor aᵢⱼ by:
aᵢⱼ=sᵢⱼdᵢⱼ,
wherein sᵢⱼ is a substitutional effect parameter representing a substitutional effect of using the second product j to substitute the first product i; and
wherein dᵢⱼ is a dominance effect parameter representing a dominance effect of the first product i to sale of the second product j.

16. The system of claim 15, wherein the computer executable code is configured to determine the substitutional effect parameter sᵢⱼ by:
$${s}_{ij} = \frac{\overline{{q}_{ij}} - \overline{{u}_{j}}}{1 + {Σ}_{k} \overline{( {q}_{ik}} - \overline{{u}_{k} )}} ,$$
wherein q̅ᵢ̅ⱼ̅ represents an average sale amount of the second product j when the first product i is out of stock in a third predetermined time, u̅ⱼ̅ represents an average sale amount of the second product j in the third predetermined time, q̅ᵢ̅ₖ̅ is an average sale amount of one of k products when the first product i is out of stock in the third predetermined time, u̅ₖ̅ represents an average sale amount of the one of the k products in the third predetermined time, k is a positive integer, and the k products and the product t i belong to a same product category.

17. The system of claim 16, wherein the computer executable code is configured to determine the dominance effect parameter dᵢⱼ by:
$${d}_{ij} = \frac{{r}_{i}}{{Σ}_{q ∈ C ( j )} {r}_{q}} ,$$
wherein rᵢ is a sale price of the first product i, O(j) is a set of products clicked within a fourth predetermined time prior to the sale of the second product j, q is an index for the products in the set O(j) and is a positive integer, and r_{q} is a sale price of the product q.

18. The method of claim 17, wherein the first predetermined time is half a year, the second predetermined time is two weeks, the third predetermined time is half a year, and the fourth predetermined time is two weeks.

19. A non-transitory computer readable medium storing computer executable code, wherein the computer executable code, when executed at a processor of a computing device, is configured to:
receive a plurality of customer clicks on the first product;
determine a click CDV for each of the customer clicks based on profits of a plurality of second products associated with the customer click; and
calculate the product CDV of the first product by averaging the click CDVs for all of the customer clicks on the first product.

20. The non-transitory computer readable medium of claim 15, wherein the computer executable code is configured to determine the click CDV by:
identifying a set O(i) of the second products j association with a customer click i of the customer clicks, wherein each of the second product j in the set O(i) is purchased by the customer performing the customer click i within a second predetermined time after the customer click i;
retrieving a profit wⱼ for selling each of the second products j in the set O(i);
derive, for each product j in the set O(i), an explanatory power factor aᵢⱼ according to click history and sales history of the first product, the second products, and products associated with the first and second products; and
calculate the click CDV vᵢ for the customer click i by:
vᵢ=Σ_{jϵO(i)}aᵢⱼwᵢ,
wherein i is an index for the customer click i, j is an index for the second products in the set O(i), and i and j are positive integers.
